(19) United States
(12) Patent Application Publication
(10) Pub. No.: US 2014/0039974 A1
(43) Pub. Date: Feb. 6, 2014

(54) SYSTEM AND METHOD FOR USING CREDIT/DEBIT CARD TRANSACTION DATA AS A MEASURE OF CUSTOMER SATISFACTION WITH A MERCHANT

(71) Applicants: Peter GROARKE, Dublin (IE); Stephen WHITNEY, Dublin (IE)

(72) Inventors: Peter GROARKE, Dublin (IE); Stephen WHITNEY, Dublin (IE)

(73) Assignee: MASTERCARD INTERNATIONAL INCORPORATED, Purchase, NY (US)

(21) Appl. No.: 13/564,398

(22) Filed: Aug. 1, 2012

(51) Int. Cl. G06Q 30/02

(52) U.S. Cl. 705/7.29

(57) ABSTRACT

A system and a method for determining customer satisfaction with a selected merchant based on chargeback transaction data in a database of transactions. An indication, which can be a number representative of customer satisfaction, is generated by comparing the number of chargeback transactions for the selected merchant with the total number of transaction not involving chargebacks for that merchant. The comparison can be made during various time periods, such as from a month to a year. The indication representative of customer satisfaction for selected merchants may be made available to merchants and to consumers, so that comparisons may be made to other businesses to help make decisions concerning improving performance for a merchant, and for deciding from which merchant a consumer should make a purchase. The data is collected automatically as a result of the transactions, without requiring input from the consumer.

### BACKGROUND OF THE DISCLOSURE

1. Field of the Disclosure

The present disclosure relates to payment card systems. More particularly, it relates to a system and a method for determining customer satisfaction with a merchant based on transactions conducted using payment card systems.

2. Description of the Related Art

The first credit payment systems were two party systems in which a merchant sold goods to a customer without requiring full or any initial payment, and the customer paid for the goods at a later date, or made periodic payments over a predetermined period of time. These two party system methods of payment are of limited scope, and are not flexible in that they involve only one merchant, and the customer must make individual arrangements with each and every merchant, and for each and every transaction.

In a three party system, a single card issuer contracts with customers and issues credit cards to them. The issuer also contracts with merchants, who agree to make sales to customers having a credit card from the issuer. When a card is presented at a merchant's establishment, it is generally the issuer who approves the transaction and pays the merchant. However, this system, a so-called closed system, has occasionally been modified so that another party approves the transaction and interacts with the merchant.

MasterCard, the assignee of the present application, operates within what is known as a “four-party” payment card system. The four key participants in a four-party system are: (i) the consumer and business cardholders that use the cards; (ii) the merchants that accept the cards; (iii) the financial institutions that issue the cards (referred to as the card issuer); and (iv) the financial institutions that sign up merchants to accept the cards (referred to as the acquirer). In a typical four-party payment card transaction, the merchant pays a “merchant discount fee” (i.e., a merchant service charge) to the acquirer in recognition of the services provided by the acquirer in facilitating payment card acceptance by the merchant. However, a substantial portion of the benefits that the merchant receives through card acceptance comes from the value of the network and services performed by the card issuer. For example, the card issuer underwrites and extends credit to the cardholder of a credit card, which enables the sale. The card issuer assumes the risk of nonpayment by the cardholder, which enables the merchant to get paid for the transaction even if card issuer does not. To compensate the card issuer for providing such benefits to the acquirer's merchant customer, the acquirer pays an “interchange fee” to the card issuer in connection with a payment card transaction. The interchange fee helps to partially reimburse the card issuer for the many activities it performs and costs it incurs that enable the acquirer to provide significant benefits and value to its merchant customers. Interchange fees are only one of the many cost components of the merchant discount fees that are established by acquirers and paid by merchants in exchange for card acceptance services provided by acquirers to merchants.

In general, the transaction system and associated methods described above work. However there are situations in which a refund of a purchase price must be provided to a customer. In some cases, a particular merchant may be engaging in undesirable business conduct, or may be selling products that do not meet customer expectations.

Currently, many online purchasing sites utilize prior customer feedback as a measure of prior customer satisfaction with a merchant. Feedback is sometimes scored, as for example on eBay®, and prospective purchasers often consider the feedback score when weighing whether to purchase from that merchant or not. However, this system is flawed. It relies on an action by the prior purchasers. Many customers, whether satisfied or not, have no desire to leave feedback. In particular, the results may be skewed to show what appears to be overall dissatisfaction with a merchant because customers having no reason to complain may elect to ignore satisfaction surveys. Therefore, such customer satisfaction inquiry systems only capture what may be a small sample size of the numerous experiences of prior purchasers with that merchant, and misleading results may be produced.

There is another way in which data relating to consumer dissatisfaction is generated. This is based on chargeback information. The term chargeback typically refers to the return of funds to a consumer, forcibly initiated by the issuing bank of the instrument used by a consumer to settle a debt. Specifically, a chargeback is the reversal of a prior outbound transfer of funds from a consumer's bank account, a line of credit, or a credit card. A chargeback is initiated by a customer by contacting the issuing bank, and filing a complaint regarding one or more debit items on the customer's statement. Among other reasons, a customer will initiate a chargeback when goods or services are not delivered within a specified time frame, goods received are damaged, or the purchase was not authorized by the cardholder. However, of particular significance is that when a customer initiates a chargeback, generally there is no additional action that a customer must take to document the customer's dissatisfaction.

### SUMMARY OF THE DISCLOSURE

The present disclosure provides a system and a method for determining the extent of customer satisfaction with a selected merchant or merchants.

The present disclosure also provides such a system and a method that derives an indication representative of customer satisfaction during a selected period of time, ranging from, for example, a month to a year.

Data in a database of, for example, payment card transactions is accessed via a web site to allow merchants and consumers to determine customer satisfaction with a selected merchant. An identification of the selected merchant or merchants may be entered into an Internet connected device, and when the web site is used, an indication concerning customer satisfaction with the merchant or merchants, is received. The indication can be based on chargeback information.

The present method can be used in a three or four party payment card processing system.

The present disclosure further provides a computer readable non-transitory storage medium storing instructions of a computer program, that when executed by a computer system, result in performance of steps of the method described for determining customer satisfaction with a merchant.

### BRIEF DESCRIPTION OF THE DRAWINGS

FIG. 1 is a diagram of a four party payment card system.

FIG. 2 is a block diagram of a portion of a payment card system modified in accordance with one aspect of the present disclosure.

FIG. 3 is a flow chart representing the manner in which acquired data is filtered.

FIG. 4 is a flow chart illustrating the manner in which the system in accordance with the present disclosure is used.

A component or a feature that is common to more than one drawing is indicated with the same reference number in each of the drawings.

### DESCRIPTION OF THE PREFERRED EMBODIMENT

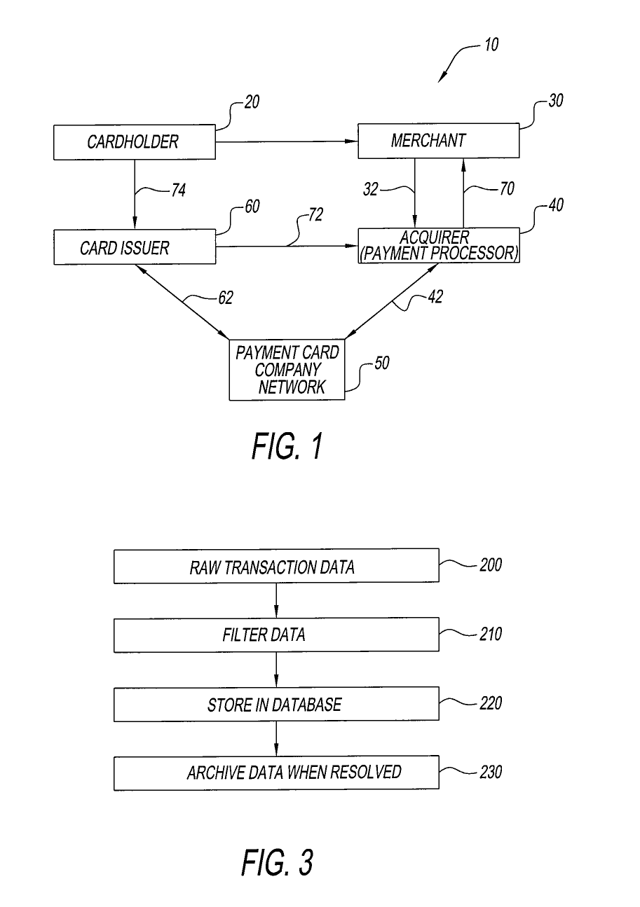

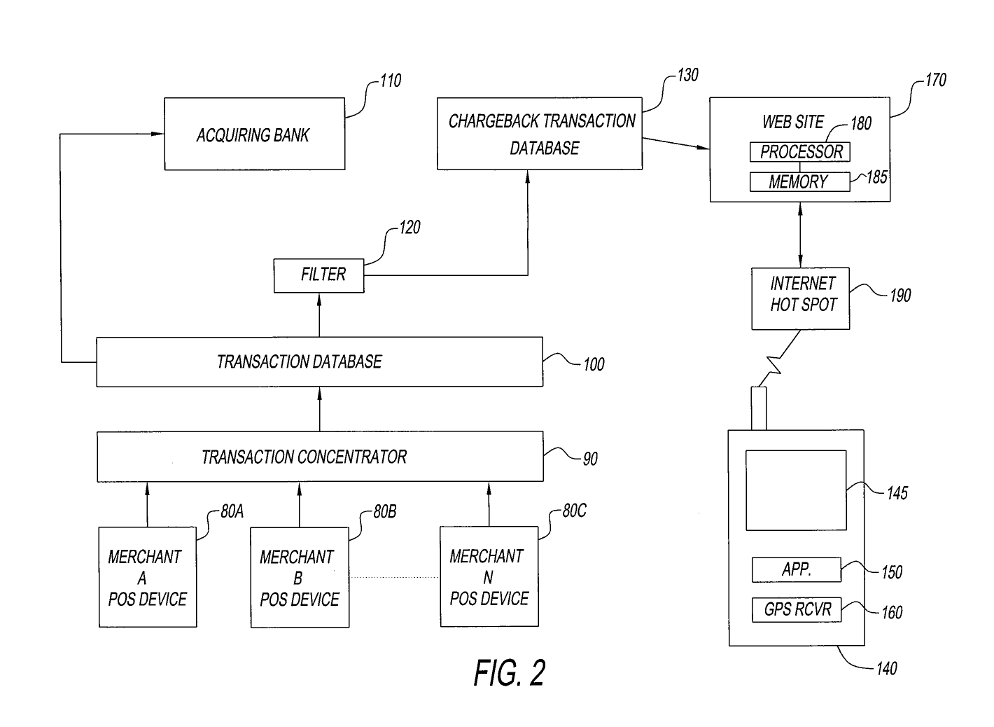

Referring to the drawings and, in particular, FIG. 1, there is shown a four party system 10. The cardholder 20 submits the credit card to the merchant 30. The merchant's point of sale device (80 in FIG. 2) communicates 32 with his acquiring bank or acquirer 40, which acts as a payment processor. The acquirer 40, at 42, initiates the transaction on the payment card network 50. The payment card network 50 routes the transaction to the issuing bank or card issuer 60, which is identified using information in the transaction message, more fully described below. The card issuer 60 approves or denies an authorization request. At 62, the card issuer 60, then routes, via the payment card network 50, an authorization response back to the acquirer 40. The acquirer 40 sends approval to the POS device of the merchant 30. Seconds later, the cardholder completes the purchase and receives a receipt.

The account of the merchant 40 is credited at 70 by the acquirer 40. The card issuer 60 pays the acquirer at 72. Eventually, at 74, the cardholder 20 pays the card issuer 60.

Referring to FIG. 2, each merchant has on their premises at least one point of sale device 80, such as a card swiping machine or some other type of device well known in the art for initiating customer transactions. These point of sale devices 80A, 80B, . . . 80N, generally also have keyboard data entry pads for instances when it becomes necessary to enter data manually, such as when a card's magnetic coding becomes difficult to read, or when the customer provides card data by telephone. Point of sale devices 80A, 80B, . . . 80N are connected by a suitable network to a transaction concentrator 90, for a given geographic area, which concentrates the transaction information. Each concentrator 90 has associated with it a transaction database 100 that stores information concerning the transaction. Transaction database 100 may acquire information from more than one concentrator 90, and thus may include data from a wide geographic area. Information from the concentrator 90 also is routed to a respective acquiring bank 110 that, in turn, routes the information so that transactions are properly completed using the system illustrated in FIG. 1.

While it is advantageous to maintain a local database including transactions in a given geographic area, there is no such limitation on various embodiments of the present disclosure. For example, if the present disclosure is used with a three party system, data for a relatively large geographic region may be stored in a single database at a central location. The time to search this more extensive database, and provide a response to a user, may be slightly greater, but the user will obtain the same useful information.

Information that is exchanged across the network for each credit or debit card financial transaction message includes the following characteristics: acquirer identifier/card accepter identifier (the combination of which uniquely defines the merchant); merchant address (i.e., full address and or GPS data); merchant category code (also known as card acceptor business code), that is an indication of the type of business the merchant is involved in (for example, a gas station); local transaction date and time, cardholder base currency (i.e., U.S. Dollars, Euros, Yen, etc.), the transaction environment or method being used to conduct the transaction, product specific data such as SKU line item data, and cost of the transaction.

Transaction records stored in transaction database 100 contain information that is highly confidential and must be maintained as such to prevent fraud and identity theft. The transaction records stored in transaction database 100 are sent through a filter 120 (FIG. 3) that removes confidential or other sensitive information, but retains records concerning merchant identification and the occurrence of transactions at various times; preferably in real time. The filtered data is stored in a chargeback transaction database 130, which may be accessed as described below. The data of the database may be stored in any type of memory, including a hard drive, a flash memory, on a CD, in a RAM, or any other suitable memory.

Filter 120 can also be used to filter out all transactions except those containing chargebacks. This provides a database of a much more manageable size. However, for the reasons explained below with respect to computing a number representative of customer satisfaction, a record should be provided for the total number of transactions not requiring chargebacks for each merchant for which there are transaction in database 100.

The following example of an approach to accessing the data involves a mobile telephone. However, it will be understood that that there are various other approaches, technologies and pathways that can be used, as further explained below.

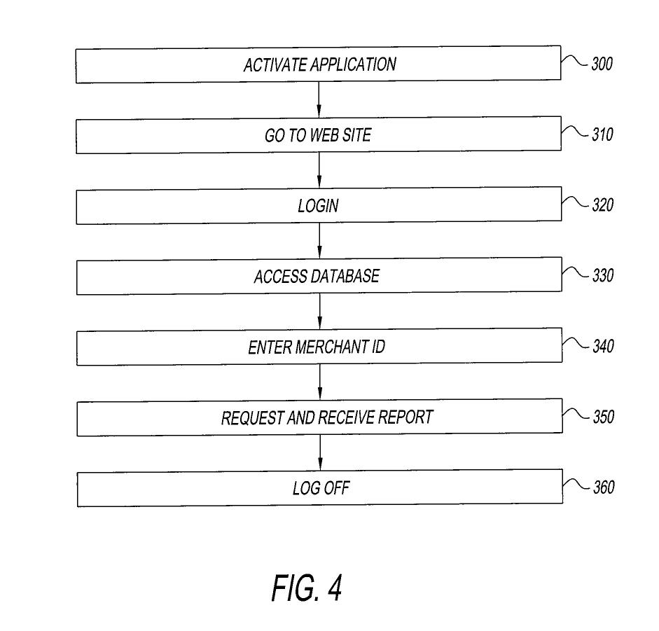

A mobile telephone 140 having a display 145 may be used to access a website 170 on the Internet, via an Internet connected Wi-Fi hot spot 190 (or by any telephone network, such as a 3G or 4G system, on which mobile telephone 140 communicates) by using application 150 that is designed for use with the embodiment described herein. Mobile telephone 140 can also have a GPS receiver 160 for providing information on the location of mobile telephone 140. Alternatively, location information can be entered by using a function of application 150. The availability of location information can be useful to a consumer, as explained below with respect to FIG. 4.

Website 170 is linked to chargeback transaction database 130 so that authorized users of website 170 may have access to the data contained therein. The manner in which that access is exploited, in accordance with the present disclosure, is described with respect to FIG. 4.

Web site 170 has a processor 180 for assembling data from chargeback transaction database 130 for responding to user inquiries. Web site 170 is more fully discussed below with respect to FIG. 4. A memory 185 associated with web site 170 has a non-transitory computer readable medium, and stores computer readable instructions for use by processor 180 in implementing the operation of the present embodiment.

The system and method described herein are preferably used by consumers who are shopping with a mobile device. In general, it may advantageously serve individuals who are away from a home or business location, and would like to receive consumer satisfaction information, so that purchases that may be influenced by the information received can be initiated promptly, or avoided. However, it will be understood that web site 170 may be accessed from a home or a business computer, including a desk top, lap top, or notebook computer, from a personal digital assistant, or any other Internet connected device, such as a tablet (for example, a device such as an iPad®). A desktop home or a business computer can be the preferred access path for merchants who occasionally wish to check their own consumer satisfaction results, but do not wish to use a mobile device.

Referring to FIG. 3, the operation of filter 120 of FIG. 2 is illustrated. The raw transaction data usually exchanged over the network is acquired at 200. At 210, customer sensitive information such as the credit card number and expiration date and other customer sensitive information is removed. All transactions except those associated with a chargeback are generally filtered out as well. At 220, the remaining data is stored in chargeback transaction database 130 (FIG. 2). At 230, data which is no longer necessary, due to a chargeback being made without any dispute by the merchant, or a chargeback dispute having been resolved, is no longer considered current (or has become “old” in the context of the present embodiment), and can be removed from the database, to an archive. This serves to conserve space in the memory associated with chargeback transaction database 130.

FIG. 4 illustrates the manner in which the present system or method is used by a consumer or a merchant. At 300, the user activates application 150 on mobile telephone 140 (FIG. 2). A merchant using a home or business computer simply actives a web browser. Assuming that Internet access to website 170 (FIG. 2) is available, at 310, unless free public access is provided, the user will be directed to a log-in page of website 170. At 320, the user logs in with a user identification or name and password in a conventional manner well known in the art. At 330, access is granted to the information in chargeback transaction database 130.

The manner in which the owner of web site 170 exploits the present system and method can vary. The web site may be available free to selected merchants; for example those having at least a given monthly or annual sales volume. Alternatively, a user fee may be charged, on a time of use, or periodic basis (such as monthly). Web site 170 may be made available only to merchants conducting transactions with cardholders of the type of card being used to make those transactions, or only for free to such merchants. The web site can be made available to consumers using the same general approaches, such as to specific cardholders, for specified merchants or merchants selling goods of a particular kind, on a fee basis, or without charge. There are other possibilities for providing access to the web site.

At 340, using a screen provided by application program 150 on mobile telephone 140, the user enters the identification for a selected merchant or merchants. This can be defined in a variety of ways. For chain stores or outlets, the information may be available for the entire chain, or for a selected store in a specific location. For individual merchants, information will only be available for the specific store.

When a chargeback transaction system is entered into the system, a reason for the chargeback is generally provided. Some of these reasons may be technical in nature, such as a duplicate transaction or insolvency of the merchant. Generally, with respect to consumer satisfaction, the reasons fall into the following categories: A. Services not provided or rendered; B. Merchandise not received, C. Defective Merchandise; and D. Goods or Merchandise is not as described. These reasons are available in chargeback transaction database 130, and can be compiled and provided as part of a report on the percentage of chargebacks associated with each one of these reasons.

What is of most interest to the consumer or the merchant is an indication representative of customer satisfaction. This indication can be provided in various ways and various forms, as described below. The indication can be a letter grade or a color indicative of customer satisfaction. In another case, the indication may be a report which can include information on the reason for the chargeback. The indication can be the actual number of chargebacks from a merchant, or it may be a number that is computed to be representative of customer satisfaction. This number may be computed as a percentage of transactions where there are no chargebacks, so that the closer this number is to one hundred percent, the greater the customer satisfaction rating of the merchant. This description is not meant to be limiting, but merely to present examples of the types of indications that can be provided. Others may occur to those skilled in the art.

Thus, this number may be computed by dividing the number of chargeback transactions for the selected merchant by the total number of transactions other than chargeback transactions conducted by the selected merchant to find a quotient, subtracting the quotient from one to define a difference, and multiplying the difference by one hundred.

There are other computations that may be made of a more complex nature, and the results may be provided to the customer as follows.

At 350, the customer requests from the web site, a report on the selected merchant or merchants for which identification data has been entered using application 150 on mobile telephone 140. Web site 170 may contain a database of merchants, and when data is entered to identify a selected merchant or merchants, an autocomplete function for the name may be provided. When the request for a report is sent by the user, shortly thereafter, a report is received and displayed on display 145 of mobile telephone 140. The report may contain just the number representative of customer satisfaction for a particular merchant. The report may also contain information as to the percentage of each reason given by customers for requesting a refund, as noted above. Thus, for example, if the customer is sure of the exact product the consumer wishes to buy, a high percentage of reasons C. and D., as set forth above, will not be of great significance.

The report may compare the number representative of customer satisfaction for several merchants for which identifying information was sent to the web site 170. If geographic information is provided, the report can also specify customer satisfaction for merchants in a selected geographic area, or merchants in a specified business in a selected geographic area, based on GPS data supplied by GPS receiver 160, or entered via application 150.

Thus, it is clear that the embodiments of the present disclosure described herein benefit merchants, as they can receive information on the satisfaction of their customers, if they have not otherwise been tracking such information. Merchants may also receive competitive information on the customer satisfaction of other merchants. The system and method benefit consumers by allowing the consumers to make informed choices, by providing customer satisfaction data concerning a merchant or merchants from whom they may wish to purchase a product or service. The payment card system operators and the acquiring banks receive the benefit of having the ability to carefully track those merchants with excessive chargebacks so that they can require reimbursement based on improper business conduct, or revoke a merchant's ability to use their payment card system.

It will be understood that while the present disclosure has been described primarily with respect to the four party credit card system, it can also be applied, as noted above, to a three party credit card system. Further, with suitable modifications, as will be understood by one skilled in the art, it can be applied to other kinds of payment card systems, such as debit card charging systems.

Various non-overlapping ranges of the number representative of customer satisfaction can be converted into different types of indicators, such as colors ranging from green for excellent, to red for poor. Alternatively, grades of A, B, C, D and F can be assigned to these ranges. The report on display 145 of mobile telephone 140 can be structured to show these indicators in addition to or instead of the number representative of customer satisfaction. If geographic data is available, a map can be displayed with the location of merchants near mobile telephone 140, indicating the customer satisfaction rating of each merchant. The locations displayed can be for merchants in a specific type business.

It will be understood that the present disclosure may be embodied in a computer readable non-transitory storage medium storing instructions of a computer program which when executed by a computer system results in performance of steps of the method described herein. Such storage media may include any of those mentioned in the description above.

The terms “comprises” or “comprising” are to be interpreted as specifying the presence of the stated features, integers, steps or components, but not precluding the presence of one or more other features, integers, steps or components or groups thereof.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A system for determining customer satisfaction with a merchant, comprising:
an electronic storage device having a database of merchant transactions stored therein;
an access path for allowing access to information concerning the transactions, wherein the information includes merchant chargeback information; and
a processor for assembling the information concerning merchant chargeback information for a selected merchant, and for computing from the assembled information an indication representative of customer satisfaction for the selected merchant.

2. The system of claim 1, wherein the indication representative of customer satisfaction is a number and the processor computes the number, in part, by dividing a number of chargeback transactions for the selected merchant by a total number of transactions other than chargeback transactions conducted by the selected merchant.

3. The system of claim 1, wherein the indication representative of customer satisfaction is a number and the processor computes the number as a percentage of satisfied customers by dividing the number of chargeback transactions for the selected merchant by the total number of transactions other than chargeback transactions conducted by the selected merchant to find a quotient, by subtracting the quotient from one to define a difference, and multiplying the difference by one hundred.

4. The system of claim 1, wherein the indication representative of customer satisfaction is a number and the processor computes the number using merchant transactions conducted during a period select from the group consisting of one month, three months, six months and twelve months.

5. The system of claim 1, wherein the database has payment card transaction data, and the data is filtered to remove cardholder information related to the transactions.

6. The system of claim 1, wherein data in the database contains payment card transaction data, and the data is filtered to remove transactions not having chargebacks.

7. The system of claim 1, wherein the access path comprises a web site for making the data in said database available to users of the web site.

8. The system of claim 7, wherein the access path includes an Internet connected device for connecting to the web site.

9. The system of claim 8, wherein the Internet connected device is one selected from the group consisting of a mobile telephone, a computer, a tablet, and a personal digital assistant.

10. The system of claim 8, wherein the Internet connected device includes a data entry device for entering one or more selected merchants, and a display for display a report including the number representative of customer satisfaction for the one or more selected merchants.

11. A method for determining customer satisfaction with a merchant, comprising:
storing in an electronic storage device a database of merchant transactions;
accessing information in the database concerning chargebacks for a selected merchant;
assembling the information concerning merchant chargebacks for the selected merchant; and
computing an indication representative of customer satisfaction for the selected merchant.

12. The method of claim 11, wherein the indication representative of customer satisfaction is a number and the number is computed, in part, by dividing the number of chargeback transactions for the selected merchant by the total number of transactions other than chargeback transactions conducted by the selected merchant.

13. The method of claim 11, wherein the indication representative of customer satisfaction is a number and the number is computed as a percentage of satisfied customers by dividing the number of chargeback transactions for the selected merchant by the total number of transactions other than chargeback transactions conducted by the selected merchant to find a quotient, subtracting the quotient from one to define a difference, and multiplying the difference by one hundred.

14. The method of claim 11, wherein the indication representative of customer satisfaction is a number and the number is computed for a period select from the group consisting of one month, three months, six months and twelve months.

15. The method of claim 11, wherein the data in the database concerns payment card transactions, and wherein the method further comprises filtering the data to remove cardholder information related to the transactions.

16. The method of claim 11, wherein the data in the database concerns payment card transactions, and wherein the method further comprises filtering the data to remove transactions not having chargebacks.

17. The method of claim 11, wherein said accessing comprises using a web site for making data in the database available to users of the web site.

18. The method of claim 11, wherein said accessing comprises using an Internet connected device for connecting to the web site.

19. The method of claim 18, wherein the Internet connected device is one selected from the group consisting of a mobile telephone, a computer, a tablet and a personal digital assistant.

20. The method of claim 11, further comprising entering data to select one or more selected merchants, and receiving a report including as the indication representative of customer satisfaction a number for the one or more selected merchants.

21. A computer readable non-transitory storage medium storing instructions of a computer program which when executed by a computer system results in performance of steps of:
storing in an electronic storage device a database of merchant transactions;
accessing information in the database concerning chargebacks for a selected merchant;
assembling the information concerning merchant chargebacks for the selected merchant; and
computing an indication representative of customer satisfaction for the selected merchant.
